(19) United States
(12) Patent Application Publication
(10) Pub. No.: US 2026/0111211 A1
(43) Pub. Date: Apr. 23, 2026

(54) INSTALL SET COMPONENT CACHING

(71) Applicant: Hewlett Packard Enterprise Development LP, Spring, TX (US)

(72) Inventors: Toran Kent Kopren, Fort Collins, CO (US); Kiran Chandra Senapati, Bangalore (IN); Soma Bhargava Nagabhushanam, Bangalore (IN); Punit Mathur, Bangalore (IN); Milan Maragiri Lakshmikanthappa, Bangalore (IN); Mohanapriya Rathinasamy, Bangalore (IN)

(21) Appl. No.: 19/018,135

(22) Filed: Jan. 13, 2025

(30) Foreign Application Priority Data
Oct. 22, 2024 (IN) 202411080465

(51) Int. Cl. G06F 8/65; G06F 8/61

(52) U.S. Cl. CPC G06F 8/65; G06F 8/61

(57) ABSTRACT

Install set component caching operations are provided herein. A component package cache of a download management system may cache downloaded install set components, enabling the components to not be redownloaded for subsequent hardware updates and/or software updates using the same components. In this manner, the overall efficiency of the update process may improve by reducing duplicative downloads.

### BACKGROUND

The present disclosure relates generally to install set component download management. More specifically, the present disclosure relates to managing caching of install set components (e.g., used in hardware updates and/or software updates, such as firmware updates, driver updates, and other software updates) based upon a determined hardware and/or software inventory.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the digital world, ever-increasing computer functionalities are available for access and use. With the increase in computer functionalities comes increased use of complex infrastructures of computer, network, and data components to facilitate these functionalities. Over time, these infrastructures may undergo updates to remain compatible with software or hardware technological developments. As infrastructures continue to expand, so too do the updates for components of the infrastructure. Thus, technological burdens of managing the updates may also continue to increase. For example, a system may have hundreds of servers that each are to undergo a firmware update.

### DRAWINGS

Features, aspects, and advantages of the present disclosure will become better understood when the following detailed description is read with reference to the accompanying drawings in which like characters represent like parts throughout the drawings, wherein:

FIG. 1 is a diagram, illustrating a download management system coupled between on-premises infrastructure (e.g., a server) and off-premises infrastructure (e.g., inventory-based install set identification system, component repository), in accordance with aspects of the present disclosure;

FIG. 2 is a flowchart, illustrating a process for generating a component package based on an install set component in a component package cache of FIG. 1, in accordance with aspects of the present disclosure;

FIG. 3 is a flowchart, illustrating a process for generating an inventory-specific component package based on the component package cache of FIG. 1, in accordance with aspects of the present disclosure;

FIG. 4 is a diagram, illustrating the download management system of FIG. 1 maintaining downloads of multiple install sets based on a component status database of FIG. 1, in accordance with aspects of the present disclosure;

FIG. 5 is a flowchart, illustrating the process of FIG. 3 including a process for retrying a download when downloading an install set component results in an error, in accordance with aspects of the present disclosure;

FIG. 6 is a flowchart, illustrating a process for generating an install set based on an entitlement identified through one or more enterprise-specific rules, in accordance with aspects of the present disclosure; and

FIG. 7 is a diagram, illustrating a computer-readable medium storing instructions to cause caching an install set component in the component package cache of FIG. 1 for subsequent use, in accordance with aspects of the present disclosure.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Over time, computing infrastructure may undergo hardware updates and/or software updates to remain compatible with software or hardware technological developments. As infrastructure size and complexity continue to increase, technological burdens of managing the updates (e.g., hardware updates and/or software updates, such as firmware updates, driver updates, other software updates) may continue to increase. Systems may have vast numbers of components (e.g., servers, data storage components, and/or network components) that each make use of updates. To help manage the updates and other provisioning operations, a system may be disposed at an edge between on-premises computing infrastructure (e.g., enterprise servers and computers) and off-premises computing infrastructure (e.g., cloud-computing infrastructure).

In some systems, an on-premises manager device has traditionally managed updates for servers or other shared infrastructure devices. To do so, the on-premise manager device may download the update from a cloud service provider. When an update is desired, the on-premises manager device may download all the install set components associated with the update, regardless of a specific configuration of components (e.g., inventory of sub-components) of the components that are on-premises. This may lead to wasted time and computing resources in downloading more install set components of the update than are used to provision the on-premises implementation. Moreover, existing techniques do not cache component downloads. This sometimes results in the set of components being re-downloaded for each update, leading to wasted time and network resources spent downloading components and wasted computing resources in coordinating and downloading the components.

Accordingly, the present disclosure relates generally to adapting update operations to include tailored inventory-based sub-component downloading and caching. More specifically, the present disclosure relates to adapting update operations to reduce un-used component downloads and avoid repetitive downloads through caching and real-time management of the caching.

In contrast to traditional on-premises manager devices, the present disclosure provides a solution that enables a configuration-specific inventory-based install set to be provided to a download management system (e.g., on-premises manager device) to guide inventory-tailored component downloads from an off-premises component repository.

Because many components of the same and/or similar configuration may exist within a given infrastructure, it may be beneficial to cache these inventory-tailored component downloads for use with other components in the infrastructure. Thus, the download management system may cache the downloaded components so that the components may not be redownloaded for similarly configured devices within the same premises. In this manner, the overall efficiency of the update process may be improved. Indeed, with many devices within a premises sharing similar configurations, far fewer download resources, both in time and bandwidth, may be used.

To elaborate, the download management system may tailor downloaded updates based upon component configuration. This may be done by sending a configuration or inventory data of a device (e.g., server, shared infrastructure) to an identification system (e.g., inventory-based install set identification system). The identification system may identify, based on the configuration or inventory data of the device, specific subsets of install set components to be installed on the device. The identification system may indicate the specific subsets of components in an install set (e.g., inventory-based install set). Because many device configurations are identical or at least similar, downloaded components of the install set may be cached so that the components may not be redownloaded if another update is based on the same component. For example, updates of firmware for devices with similar inventory data or similar configurations may be the same or similar, and thus may benefit from reusing cached install set components.

Since component downloads may occur in parallel, an “on-the-fly” analysis may be used by a download management system to manage component downloads, ensuring that the download occurs once. For example, the download management system may track currently downloading components, causing other download processes associated with the downloading components to wait until the component is finished downloading and cached. In this manner, duplicative downloads may be prevented.

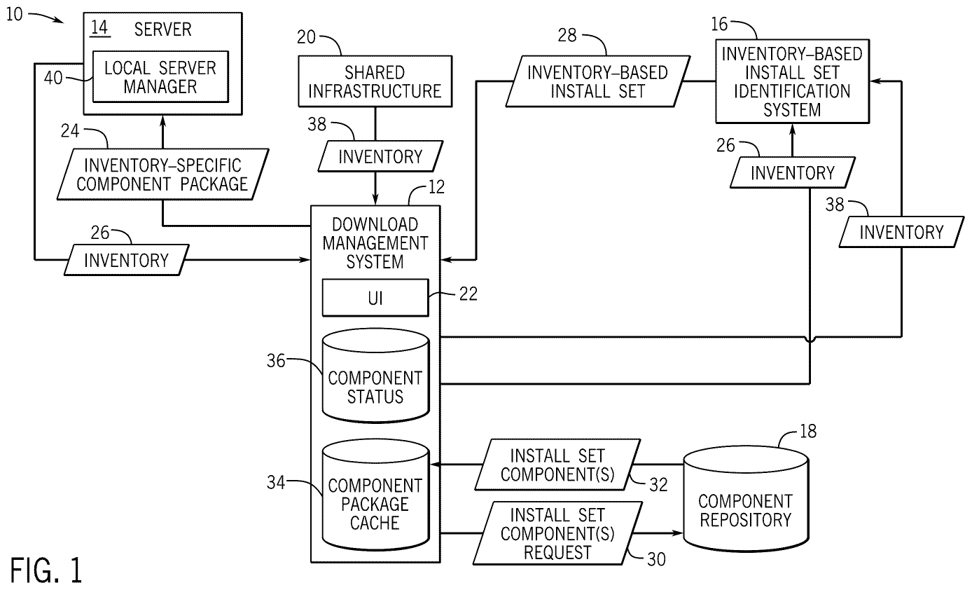

With this in mind, FIG. 1 is a diagram, illustrating a system 10 that includes a download management system 12 coupled between a server 14, an inventory-based install set identification system 16, and a component repository 18, in accordance with aspects of the present disclosure. The server 14 may be an example of an on-premises infrastructure component. The inventory-based install set identification system 16 and the component repository 18 may be an example of off-premises infrastructure component. Although described herein relative to the server 14 for ease of disclosure, it should be understood that other types of on-premises infrastructure components may benefit from the component caching systems and methods described herein. For example, such components may include any suitable computing device, database, data providing entity, components of a “bladed” environment, such as compute blade devices, enclosures or frames, network interconnect devices, disk enclosures, or the like that may be generally considered an on-premises infrastructure component, and thus may be a component of the shared infrastructure 20. Indeed, systems and methods described herein relative to the server 14 may be similarly applied to the shared infrastructure 20. The download management system 12 may be considered an edge device disposed between on-premises computing systems and cloud-accessible computing systems located off-premises. The download management system 12 may be physically disposed on-premises, or logically associated within a same enterprise infrastructure, with the server 14 and/or the shared infrastructure 20. In some cases, the download management system 12 is a cloud-based system that operates as an edge device would if on-premises while itself being physically located off-premises. The download management system 12 may be, or may be provided, as part of a software-as-a-service offering.

One or more devices illustrated in the system 10 may include any suitable computing devices that may utilize data memory and/or storage, such as servers, desktop computers, laptop computers, tablet computers, cellular devices, wearable devices, and/or other computing devices. The storage/memory may include any suitable articles of manufacture suitable for storing data and/or executable instructions. The storage/memory may include a storage device, such as a Non-Volatile Memory Express (NVMe) device, a hard disk drive (HDD), a solid-state drive (SSD), an optical drive, another type of storage device, flash memory, read-only memory (ROM), or any combination thereof. The storage/memory includes memory that may include any suitable memory devices, such as a double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof.

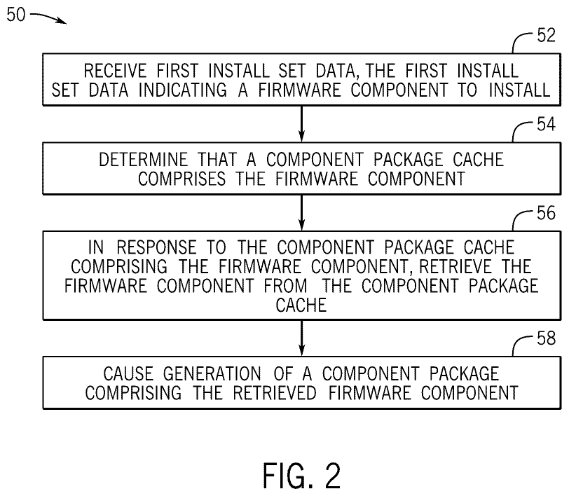

The download management system 12 may include processing circuitry operable to perform one or more operations. The download management system 12 may include input and/or output circuitry through which to receive and/or transmit signals from the server 14, the shared infrastructure 20, the inventory-based install set identification system 16, the component repository 18, or the like. The download management system 12 may include memory, which may store the component status database 36 and the component package cache 34. Similar circuitry may be included or associated with the server 14, the shared infrastructure 20, the inventory-based install set identification system 16, the component repository 18, or the like to perform or enable performance of one or more operations described herein. For example, such operations may be described herein in reference to operations of FIGS. 2-7.

The download management system 12 may perform inventory-based update downloads, which may reduce a total amount of computing resources consumed and time spent downloading the update. To do so, a user interface (UI) 22 of the download management system 12 may receive an input indicating a request to perform a check for update options. Responsive to the input, the download management system 12 may coordinate the generation of an inventory-specific component package 24, which may cause a update. Further, the inventory-specific component package 24 may be cached, to reduce time and bandwidth spent in upgrading of components having the same and/or similar configurations.

To elaborate, the download management system 12 may receive inventory data 26 and/or inventory data 38 from on-premises infrastructure components (e.g., the server 14 and/or shared infrastructure 20) and transmit the inventory data 26 and/or inventory data 38 to the inventory-based install set identification system 16. The inventory data 26 and/or inventory data 38 may include indications of hardware and software components used within the server 14 and/or the shared infrastructure 20, respectively. Of such hardware and software components, a subset of the components may be affected by a first update but not be affected by a second update. Therefore, the inventory-based install set identification system 16 may generate an inventory-based install set 28 based on the inventory data 26 and/or inventory data 38.

To do so, the inventory-based install set identification system 16 may query a database of available updates to determine a subset of those available to be applied to update on-premises components, given their specific configuration/inventory indicated through the inventory data 26 and/or inventory data 38. The inventory-based install set 28 may indicate the subset of available updates that could be applied to update on-premises inventory and corresponding install set components to be downloaded to apply a respective of the available updates. The inventory-based install set 28 may include an indication of a subset of updates of an update package to be applied to a device, like the server 14, based on inventory data 26 and/or inventory data 38. The inventory-based install set identification system 16 may transmit the inventory-based install set 28 to the download management system 12.

The download management system 12 may receive the inventory-based install set 28 from the inventory-based install set identification system 16. When more than one update is available based upon the inventory data 26 and/or inventory data 38, the inventory-based install set 28 may indicate install set components to install to perform any of the updates. More than one install set component may be indicated for each update in the inventory-based install set 28. The inventory-based install set 28 may include a list, a data structure, a look-up table, or any suitable data through which to communicate the relationship between updates available and associated install set components to perform a respective update.

The download management system 12 may update a graphical user interface presented via the UI 22 based on the inventory-based install set 28. The UI 22 may be any suitable display or output delivery device that may enable an operator to select among multiple compatible updates to initiate a selected update. After the update, the UI 22 may present graphical representations of the available updates indicated in the inventory-based install set 28. Thus, the UI 22 may present graphical representations of one or more updates eligible for application to the server 14 based on the hardware and software components of the server 14. The download management system 12 may receive, via the UI 22, a selection of an update from the one or more updates presented on the UI 22.

In response to receiving, via the UI 22, the update selection, the download management system 12 may identify a list of install set components to be used to perform the update selected. The inventory-based install set 28 may identify, relative to each indicated update, the list of install set components to be used to perform that update. For a respective update, a subset of install set components used to perform that update may be indicated in the install set (e.g., inventory-based install set 28). An install set may indicate install set components for multiple updates, where the indicated install set components may represent a subset of install set components that could be downloaded.

Some of the install set components may already be stored in a component package cache 34 and other install set components may not yet be downloaded. The component package cache 34 may cache respective components of one or more updates to be applied to one or more devices within an infrastructure, such as the server 14, the shared infrastructure 20, or the like. The download management system 12 may query a component package cache 34 and determine which, if any, of the list of install set components are already stored in the component package cache 34. For the install set components stored in the component package cache, the download management system 12 may refrain from repeating a download of those install set components. For those remaining install set components not yet in the component package cache 34, the download management system 12 may download the rest of the list of install set components indicated by the install set.

To download, the download management system 12 may transmit, to the component repository 18, an install set component request 30. The install set component request 30 may initiate a query of the component repository 18. The install set component request 30 may indicate one or more target components to be downloaded and transmitted to the download management system 12. The component repository 18 may return one or more install set components 32 in response to the install set component request 30. The install set components 32 are install set components downloaded responsive to the install set component request 30.

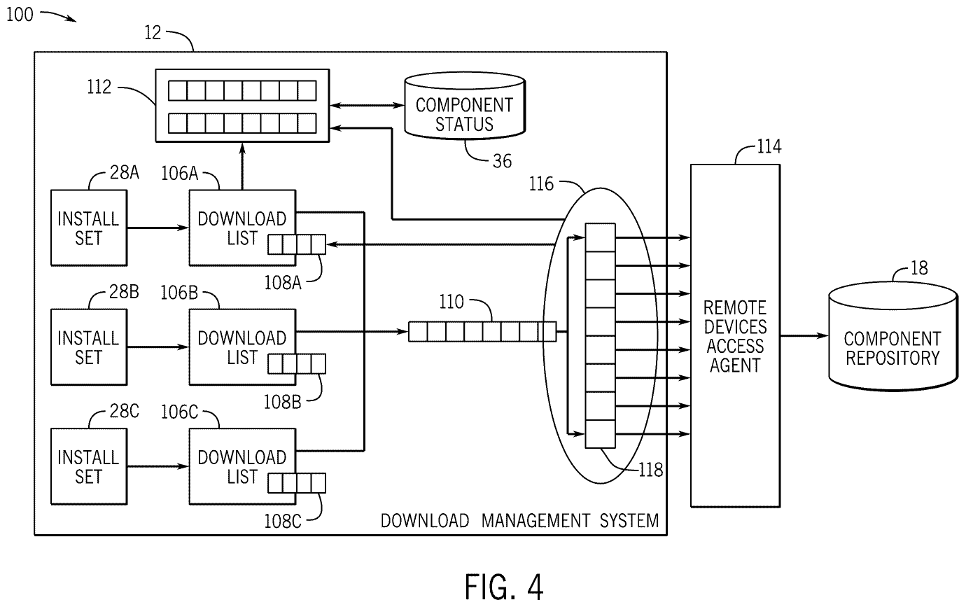

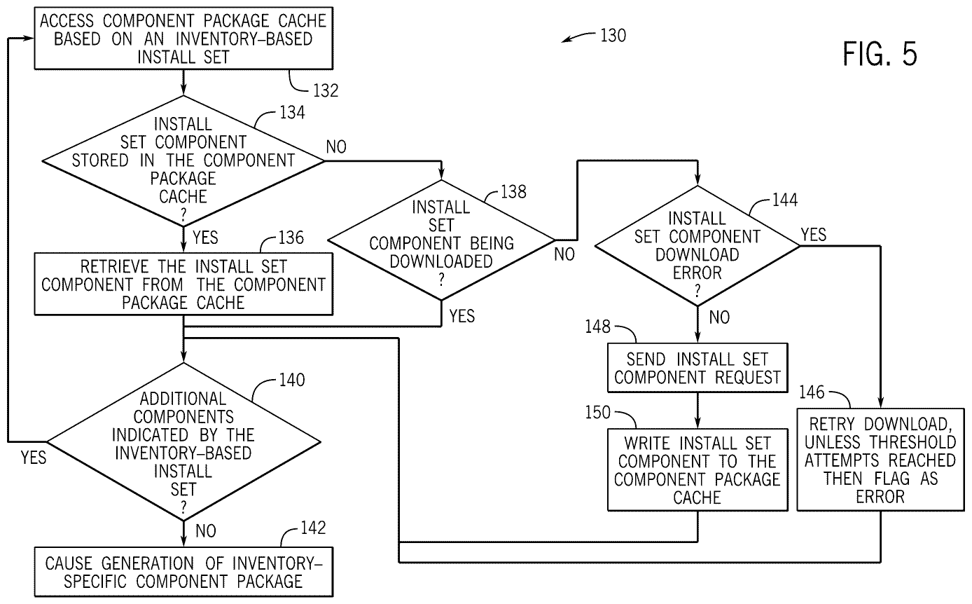

To manage the download, the download management system 12 may maintain a download status for the one or more install set components 32 in a component status database 36. This is described in detail in FIGS. 4-5. The component status database 36 may store a status for retrieved components (e.g., “downloaded” status) and a status for components being retrieved (e.g., “downloading” status). The download management system 12 may determine whether an install set component is stored in the component package cache 34 by querying the component status database 36. Indeed, the download management system 12 may maintain a download status for other install set components being downloaded at an at least partially overlapping time duration as the one or more install set components 32. For example, the shared infrastructure 20 may correspond to an inventory data 38 and its own update requests being processed by the download management system 12. The shared infrastructure 20 may use some or all of the same install set components as the server 14 to update. Maintaining a real-time indication of whether or not a respective install set component 32 is downloaded may enable the download management system 12 to reduce or eliminate a likelihood of duplicate downloads from occurring. Each component stored in the component package cache 34 may correspond to a stored status in the component status database 36.

The download management system 12 may generate and send the inventory-specific component package 24 to a local server manager 40 tasked with installing the updates (e.g., the inventory-specific component package 24). The inventory-specific component package 24 may include components read from the component package cache 34, downloaded from the component repository 18, or a combination of both. The inventory-specific component package 24 may include the install set components 32 with install set components received from the component package cache 34 (e.g., previously cached components stored in the component package cache 34). The local server manager 40, after receiving receipt, uses the components of the inventory-specific component package 24 to install the update.

When downloading the install set components 32, the download management system 12 may cache the install set components 32 in the component package cache 34 to use in other updates without repeating the download. The download management system 12 may cache a respective component in the component package cache 34 at an earlier time relative to the performance operations of process 50. Doing so enables the respective component to be available for retrieval at block 56.

Once cached, the download management system 12 may access any of the install set components 32 for use in an update, regardless of whether the entire list of install set components overlaps between the updates. In other words, caching the install set components enables the download management system 12 to use any respective cached component in a future update without redownloading that respective component, conserving computing resources and saving time to update.

Elaborating further on component caching operations, FIG. 2 is a flowchart, illustrating a process 50 for generating a component package based on a component in a component package cache 34, in accordance with aspects of the present disclosure. As mentioned above, the download management system 12 may perform the process 50 to generate the component package. However, other suitable processing circuitry may perform the process 50.

The process 50 begins with receiving first install set data (e.g., inventory-based install set 28), where the first install set data may indicate an install set component to install (e.g., for a specific inventory of a component) (block 52). The first install set data may indicate the install set component, along with one or more other install set components, to be installed to perform an update. Indeed, the first install set data may indicate additional install set components to install, such as a second install set component to install based upon inventory data (e.g., inventory data 26 and/or inventory data 38).

The first install set data may be received from the inventory-based install set identification system 16. The inventory-based install set identification system 16 may generate the first install set data (e.g., inventory-based install set 28) based on inventory data. The inventory-based install set identification system 16 may generate the first install set data independent of an indication of inventory data, such as to enable a specific update without an inventory-based query to identify compatible install set components.

A determination is made as to whether the install set component is in the component package cache 34 (block 54). The download management system 12 may determine whether the component package cache 34 stores the install set component through a query. The download management system 12 may query the component package cache 34 and determine which install set components, if any, of the list of components of the install set are already in the component package cache 34.

When the install set component is in the component package cache 34, the install set component is retrieved from the component package cache 34 (block 56). Any suitable method of retrieval may be used. The install set component may be read from the component package cache 34, copied into working memory from the component package cache 34, or the like. For example, the component package cache 34 may return the install set component in response to the query by the download management system 12.

A component package is generated based on the install set component retrieved at block 56. The component package may be an inventory-specific component package 24. The download management system 12 may send the component package to the component to be updated (e.g., server 14, component of the shared infrastructure 20, or another suitable computing device) for installation. These components/devices may include processing circuitry (e.g., the local server manager 40) to update the hardware and/or software upon receiving the component package. In some cases, the component package cache may include all of the install set components, such that there is nothing further to download to update the hardware and/or software. In some cases, the component package generated may indicate the install set component, such that the local server manager 40 may download the install set component from the download management system 12 to update the hardware and/or software.

Sometimes an inventory-specific component package (e.g., inventory-specific component package 24) is generated at block 58. The inventory-specific component package may include install set components tailored, by an off-premises system (e.g., inventory-based install set identification system 16), to inventory data provided by on-premises infrastructure (e.g., server 14, shared infrastructure 20). Thus, the process 50 may apply to generate an inventory-specific component package (e.g., inventory-specific component package 24) at block 58.

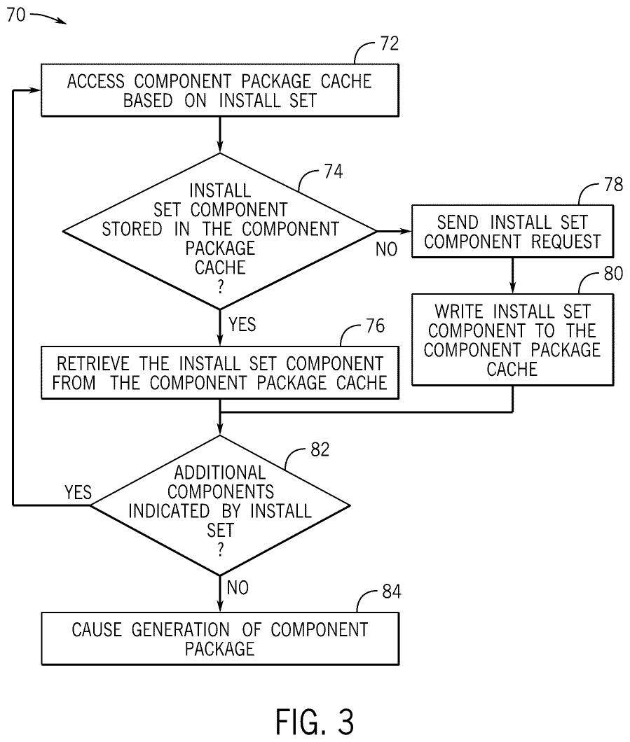

To elaborate on caching operations, FIG. 3 is a flowchart, illustrating a process 70 for generating an inventory-specific component, in accordance with aspects of the present disclosure. As mentioned above, a download management system 12 may perform the process 70 to generate the inventory-specific component package 24 based upon an install set identified from an inventory of the components to be updated. However, other suitable processing circuitry may perform the process 70.

The process 70 begins with accessing the component package cache 34 based on an install set (block 72). As noted above, the install set may indicate one or more install set components to install to update hardware and/or software. When the install set has been customized to inventory data (e.g., inventory data 26 and/or inventory data 38), the install set corresponds to an inventory-based install set (e.g., inventory-based install set 28).

While accessing the component package cache 34, it is determined whether an install set component is stored in the component package cache 34 (decision block 74). To do this, the component package cache 34 may be queried for an indication of whether the install set component is stored/cached within the component package cache 34. When the query returns an indication that the install set component is stored in the component package cache 34, the install set component is retrieved from the component package cache 34 (block 76). Any suitable method of retrieval may be used. However, when the query returns an indication that the install set component is not in the component package cache 34, the install set component request 30 is sent to the component repository 18 and/or a service connected to the component repository 18 (block 78). The component repository 18 and/or a service connected to the component repository 18 may send the install set component 32 in response to the request. In some instances, the install set component 32 may be downloaded directly from the component repository 18. Once received, the install set component 32 may be written to the component package cache 34 (block 80). Doing so preserves the install set component 32 for subsequent use.

A determination is made as to whether additional components are indicated by the install set (decision block 82). The install set may indicate more than one component when an update uses more than one component to install the updated configurations, software, or the like. When there are additional components indicated by the install set, the download process may repeat, accessing the component package cache 34 based on the install set to look for the next component of the update (block 72).

However, when there are no additional components indicated by the install set, the component package is generated (block 84). When the install set has been customized to inventory data (e.g., inventory data 26 and/or inventory data 38), the component package generated is an inventory-specific component package (e.g., inventory-specific component package 24). The component package may include one or more install set components retrieved from the component package cache 34, received from the component repository 18, or both.

FIG. 4 is a diagram 100, illustrating the download management system 12 maintaining downloads of multiple install sets 28 (install set 28A, install set 28B, install set 28C) based on a component status database 36, in accordance with aspects of the present disclosure. The multiple install sets 28 may correspond to concurrent or overlapping update requests from different infrastructure components (e.g., servers 14, components of shared infrastructure 20, or the like).

The components of updates may be identified in the respective install sets 28. Each install set may correspond to a respective selected update being managed. Some or none of the install set components may already be in the component package cache 34. Based on this, the download management system 12 may determine that some of the install set components of the install sets 28 are to be downloaded. The download management system 12 may use a parsing operation to make this determination. The download management system 12 may parse indications of the install sets 28 to identify the install set components to retrieve. Parsing may involve a syntax analysis of indicated install set components associated with a respective update. The parsing, the receipt of the install sets 28, and the processing in general may be started at different times and proceed at an at least partially overlapping time.

Install sets 28 in FIG. 4 may represent a post-selection install set 28. That is, the inventory-based install set 28 may indicate install set components for multiple updates. After selection, a subset of the install set components for the selected update may be identified. That subset may be used as install set 28 in FIG. 4. In some systems, the download management system 12 may identify the subset of the install set components as part of a parsing operation before or during downloading of the install set components. The download management system 12 may parse the inventory-based install set 28, identify components of one or more selected updates to be retrieved, and refrain from retrieving components of one or more unselected updates.

The download management system 12 may indicate in download lists 106 (download list 106A, download list 106B, download list 106C) which components from the respective install sets 28 are to be downloaded. Each install set 28 may correspond to a download list 106 and a respective of threads 108 (thread 108A, thread 108B, thread 108C). The respective threads 108 may reference the corresponding download list 106 to determine which install set component to download next.

The download management system 12 may access, via a remote device access agent 114, the component repository 18 to download install set components. The download management system 12 may pull the install set components from the component repository 18 through the remote device access agent 114 based on pool connection resources of connection pool 116. The remote device access agent 114 may pull the install set components on behalf of the download management system 12 through respective pull requests that each correspond to dedicated allocations of pool connection resources (e.g., resource allocation subset 118). As components are downloaded, or portions of components are downloaded, a download queue 110 may manage component data. The download queue 110 may transmit component data to the corresponding threads 108 for that component download.

While an install set component downloads, the download management system 12 may update an indication in the component status database 36. The download management system 12 may store, in memory, various statuses related to the downloading of install set components. In some systems, these statuses may be stored in dedicated memory resources, such as the component status database 36. While an install set component is being downloaded, the download management system 12 may associate an indication of that install set component with a “downloading” status. If an issue arises while the install set component is being downloaded and the download is paused or incomplete, the download management system 12 may associate an indication of that install set component with an “incomplete” status. Once an install set component is downloaded, the download management system 12 may associate an indication of that install set component with a “downloaded” status. The download management system 12 may store downloaded install set components in the component package cache 34 before including the install set components in a component package (e.g., inventory-specific component package 24). Data related to downloading the install set components and/or updating the statuses may be stored in memory 112, the component status database 36, or other suitable memory or storage.

While an install set component indicated in the download list 106 has the “downloading” status (e.g., as stored in the component status database 36), another thread may also be instructed to download the install set component. To avoid repeating the download of the install set component, the thread 108 may query for the status of downloading of the install set component. Upon receiving an indication of a “downloading” status, the thread 108 may pause its operation to wait for the install set component to be downloaded. The thread 108 may identify when this occurs through the install set component having the “downloaded status. ” If an error arises while downloading, the thread 108 may retry the download up to a threshold number of retries (e.g., one retry, two retries, three retries, four retries, or the like). Should the threshold number of retries be reached, the thread 108 may indicate the download error with an “incomplete”status and continue downloading install set components.

To elaborate on this parallel download management operation, FIG. 5 is a flowchart, illustrating a process 130 that includes parallel download management operations, in accordance with aspects of the present disclosure. As mentioned above, the download management system 12 may perform the process 130 to generate the inventory-specific component package 24 indicating inventory-specific install set components to install for particular on-premises components. However, other suitable processing circuitry may perform the process 130.

The process 130 begins with accessing the component package cache 34 based on the inventory-based install set 28 (block 132). The component package cache 34 is accessed to identify which, if any of the install set components of the inventory-based install set 28 are stored/cached in the component package cache 34.

While accessing the component package cache 34, it is determined whether an install set component is stored in the component package cache 34 (decision block 134). The install set component may be indicated by indicated by the inventory-based install set 28. To do this, the component package cache 34 may be queried for an indication of whether the install set component is stored (e.g., cached) within the component package cache 34. The download management system 12 may determine this based on a query of the component status database 36 and whether the component status database 36 indicates the target install set component with a “downloaded” status. In some systems, the download management system 12 may determine this based on a query of the component package cache 34 and whether the target install set component is cached.

When the query returns an indication that the install set component is stored in the component package cache 34, the install set component is retrieved from the component package cache 34 (block 136). Any suitable method of retrieval may be used.

However, when the query returns an indication that the install set component is not in the component package cache 34, it is determined whether the install set component is being downloaded (decision block 138). While downloaded, the install set component may be associated with a “downloading” status. The download management system 12 may determine this based on a query of the component status database 36 and whether the target install set component indicated with a “downloading” status. When the download management system 12 determines that the install set component is being downloaded, the download management system 12 may wait until the install set component is done being downloaded, proceeding when the status is updated to indicate the “downloaded” status. The download management system 12 may proceed with other downloads (e.g., continue to decision block 140) while the download identified at block 132 continues in parallel.

In some cases, it is determined whether additional install set components are indicated by the inventory-based install set 28 (decision block 140). The install set may indicate more than one component when an update uses more than one component to install the updated configurations, software, or the like. When there are additional components indicated by the install set, the download process may be repeated for the next component of the update. When the install set indicates an additional component, the component package cache 34 is accessed based on the install set to retrieve the additional component of the update (block 132).

However, when the install set is determined to not indicate an additional component, a component package is generated (block 142). When the install set has been customized to inventory data (e.g., inventory data 26 and/or inventory data 38), the component package generated is an inventory-specific component package, like the inventory-specific component package 24. The component package may include one or more install set components retrieved from the component package cache 34, received from the component repository 18, or both.

Returning back to decision block 138, when it is determined that the install set component is not being downloaded (decision block 138), it is determined whether the install set component is associated with a download error or otherwise “incomplete” status (decision block 144). The status of the install set component may be determined based on a query of the component status database 36. For example, the download management system 12 may query of the component status database 36 to determine if the install set component is associated with the download error, the “incomplete” status, or both. The component status database 36 indicates the target install set component with an “incomplete” status.

In response to the status showing the “incomplete” status, the download is retried (block 146). The download may be retried repeatedly until a threshold number of retries is crossed. The threshold number may be stored in memory. If the threshold number of retries is crossed, image content may be presented via the UI 22, the image content indicating that the download of that install set component is incomplete and unable to be resolved through retrying the download. For example, the download management system 12 may retry the download(s).

In response to the component status database 36 not including a status (e.g., a status being “incomplete” or “downloading”), a download of the install set component is initiated through sending an install set component request 30 (block 148). The component repository 18 and/or a service connected to the component repository 18 may send an install set component 32 in response to the request. In some instances, the install set component 32 may be downloaded directly from the component repository 18. For example, the component repository 18 may send an install set component 32 to the download management system 12 in response to the request. The download management system 12 may download the install set component 32 from the component repository 18. Once received, the install set component 32 may be written to the component package cache 34 (block 150). Doing so preserves the install set component 32 for subsequent use. The process 130 may proceed with operations at block 140 after writing the install set component 32 to the component package cache 34.

In some systems, a validation operation may be performed before the download management system 12 is permitted by the off-premises infrastructure to receive the inventory-based install set 28, the install set components 32, or the like. The validation operation may be based on tokens, geographic, or other types of entitlement data. For example, the off-premises infrastructure may be programmed to deny access to on-premises infrastructure in certain physical locations, associated with deniable-types of metadata, expired credentials, or the like.

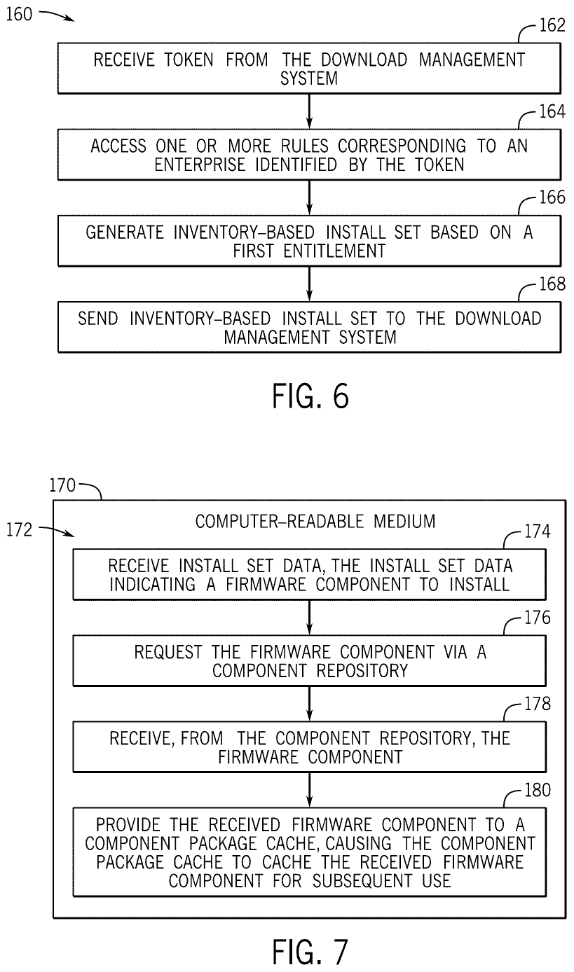

To elaborate, FIG. 6 is a flowchart, illustrating a process 160 for generating an install set (e.g., inventory-based install set 28) based on an entitlement identified through one or more enterprise-specific rules, in accordance with aspects of the present disclosure. As mentioned above, an install set identification system (e.g., inventory-based install set identification system 16) may perform the process 160 to generate the install set based on one or more entitlements identified through one or more rules, which may be specific to an enterprise associated with the on-premises infrastructure. However, other suitable processing circuitry may perform the process 160.

The process 160 begins with receiving a token from the download management system 12 (block 162). For example, the download management system 12 may transmit a token to the install set identification system. The token may indicate an entitlement characteristic that may indicate entitlement to particular updates. For example, the entitlement characteristic may include a geography or physical location of the on-premises infrastructure, and thus include a geography indication, which may be useful in identifying geographical entitlements to particular updates. The geography indication may indicate a physical location or global positioning service (GPS) coordinates of the on-premises infrastructure requesting the updates, such as the physical location or country of origin of the server 14. The token may indicate an enterprise associated with the on-premises infrastructure. The token may indicate other information to be used to verify a permission or identity of the on-premises infrastructure, the download management system 12, or the like. For example, the token may include subscription indication that indicates whether the enterprise is current on a subscription payment, or the like.

One or more rules are accessed corresponding to an enterprise identified by the token (block 164). The rules are associated with an indication of the enterprise. The rules are accessed due to the association between the rules and the enterprise, where the token indicates the enterprise. The rules may control whether the install set identification system permits or deny access by the download management system 12 on the basis of the data of the token. One or more rules may indicate permitted physical locations, permitted GPS coordinates, permitted enterprise identifies, or the like. One or more rules may instruct the install set identification system to reference subscription databases to determine whether to grant access to the download management system 12 as a subscriber.

The install set is generated based on a first entitlement permitting access to the download management system 12 (block 166). The installation set may be an inventory-based install set 28 when the download management system 12 provided inventory data (e.g., inventory data 26 and/or inventory data 38). The install set identification system may operate based on an entitlement service. An entitlement service may validate, based on an entitlement indication and the token. At validation, the download management system 12 may be granted access to update hardware and/or software. The entitlement service may validate based on the entitlement being a geography entitlement, or any of the other data included in the token.

Once validated, the install set (e.g., inventory-based install set 28) is sent (block 168). The install set may be sent to the download management system 12. The download management system 12 performs operations described herein based on the install set. For example, the download management system 12 continues on with performing operations of FIG. 5 based on the install set received responsive to block 168.

FIG. 7 is a diagram, illustrating a computer-readable medium 170 storing instructions to cause caching of an install set component in the component package cache 34 for subsequent use, in accordance with aspects of the present disclosure. The download management system 12 described herein may be any suitable computing device, such as a network device, a WLAN controller, a desktop computer, a laptop computer, a server, a web server, a mainframe, a tablet computer, an e-reader, a netbook computer, a mobile phone, a smartphone, a smart terminal, a dumb terminal, a virtual terminal, and so on. Indeed, the computer-readable medium 170 stores computer-readable instructions that, when executed by one or more processors (e.g., processors of the download management system 12) of one or more computers, cause the one or more computers to perform process 172 to cause caching an install set component in the component package cache 34 for subsequent use.

The one or more computers receive install set data (block 174). The install set data may indicate an install set component to install. The install set data may correspond to inventory-based install set 28. The first install set data may indicate the install set component, along with one or more other install set components, to be installed to update hardware and/or software. The install set components indicated in the inventory-based install set 28 may be selected for inclusion based on inventory data (e.g., inventory data 26 and/or inventory data 38).

The one or more computers request the install set component via a component repository 18 (block 176). The one or more computers may query the component repository 18 with the install set component request 30. Any suitable query may be used, such a structured database language query.

In response to transmitting the install set component request 30, the one or more computers receive, from the component repository 18, the install set component (e.g., install set component 32) (block 178). The component repository 18 and/or a service connected to the component repository 18 may send the install set component 32 in response to the request. In some instances, the install set component 32 may be downloaded directly from the component repository 18.

Before including the install set component in a component package (e.g., inventory-specific component package 24), the one or more computers provide the received install set component to the component package cache 34 (block 180). Providing the received install set component to the component package cache 34 causes the component package cache 34 to cache the received install set component for subsequent use. Doing so preserves the install set component 32 for subsequent use.

After operations of block 180, the one or more computers may cause generation of a component package comprising the received install set component. The one or more computers may generate the component package (e.g., inventory-specific component package 24) or may transmit a notification to a local infrastructure manager (e.g., local server manager 40) that the component package is ready for installation. In response to the notification, the local infrastructure manager may download install set components indicated by the component package to update the hardware and/or software.

In some cases, before receiving the install set data at block 174, the one or more computers may transmit, to an entitlement service, a token. In response to transmitting the token, the one or more computers may prepare to receive the install set data in anticipation of the entitlement service validating the token. These operations may occur in parallel or at an at least overlapping time to validation operations described relative to process 160.

The one or more computers may perform one or more operations of process 130 based on instructions stored in the computer-readable medium 170. As one example, the one or more computers may query a component status database 36. The query may indicate whether the component package cache 34 stores the install set component. The component status database 36 may store a status for an error in retrieving components (e.g., “incomplete” status). In response to the status for the error, the one or more computers may repeat retrieval of the install set component. The component status database 36 may store a status for retrieving components (e.g., “downloading” status). In response to the status for retrieving components, the one or more computers may wait until the component cache stores the install set component.

Systems and methods described herein enable a configuration-specific inventory-based install set to be provided to a download management system to guide component downloads from an off-premises component repository. Further, a component package cache of the download management system may cache the downloaded components, enabling the components to not be redownloaded for future updates based on the components. In this manner, the overall efficiency of the update process may be improved. Since many devices within a premises may share similar configurations or otherwise use the same install set components for an update, far fewer download resources, both in time and bandwidth, may be used.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A system, comprising:
a component cache configured to cache respective components of one or more updates to be applied to one or more devices within an infrastructure; and
processing circuitry configured to:
receive inventory data from a device of the one or more devices;
transmit the inventory data to an inventory-based install set identification system;
receive install set data from the inventory-based install set identification system, the install set data indicating an install set component to install based upon the inventory data;
request the install set component via a component repository;
receive, from the component repository, the install set component;
cause generation of a component package comprising the received install set component; and
provide the received install set component to the component cache, causing the component cache to cache the received install set component for subsequent use.

2. The system of claim 1, comprising the inventory-based install set identification system, wherein the inventory-based install set identification system is configured to:
generate the install set data, wherein the install set data comprises an indication of a subset of firmware updates of a firmware update package, to be applied to the device based on the inventory data.

3. The system of claim 1, wherein the processing circuitry is configured to:
receive a second install set data indicating the install set component;
determine whether the install set component is stored in the component cache;
in response to determining that the install set component is not stored in the component cache, transmit an install set component request to the component repository; and
in response to determining that the install set component is stored in the component cache, refrain from transmitting the install set component request to the component repository.

4. The system of claim 3, wherein the processing circuitry is configured to:
in response to determining that the install set component is stored in the component cache, retrieve the install set component from the component cache.

5. The system of claim 3, comprising a component status database configured to store a status for retrieved components and a status for components being retrieved, wherein the processing circuitry is configured to determine whether the install set component is stored in the component cache, by querying the component status database.

6. The system of claim 5, wherein the processing circuitry is configured to:
in response to determining that the install set component is not stored in the component cache based on the querying of the component status database, transmit the install set component request to the component repository.

7. The system of claim 1, wherein the install set data indicates a second install set component to install based upon the inventory data.

8. The system of claim 1, comprising a component status database configured to store a status for each component stored in the component cache, wherein the processing circuitry is configured to:
receiving a second install set indicating the install set component;
waiting until the component status database stores a status for retrieved components; and
in response to the component status database storing the status, retrieving the install set component from the component cache.

9. The system of claim 1, wherein the processing circuitry is configured to cause generation of the component package at least in part by:
transmitting a token to the inventory-based install set identification system, the inventory-based install set identification system comprising an entitlement service that validates, based on an entitlement indication and the token, a permission of the processing circuitry; and
receiving a second install set indicating the install set component.

10. The system of claim 9, wherein the token comprises a geography indication, wherein the entitlement service validates the install set component based on the entitlement indication being a geography entitlement.

11. A computer-implemented method, comprising:
receiving first install set data, the first install set data indicating an install set component to install;
determining that a component cache comprises the install set component;
in response to the component cache comprising the install set component and the first install set data, retrieving the install set component from the component cache; and
generating a component package comprising the retrieved install set component.

12. The computer-implemented method of claim 11, comprising:
receiving second install set data, the second install set data indicating the install set component to install;
in response to the second install set data, requesting the install set component via a component repository;
receiving, from the component repository, the install set component;
generating the component package comprising the received install set component; and
providing the received install set component to the component cache, causing the component cache to cache the received install set component for subsequent use.

13. The computer-implemented method of claim 11, comprising:
receiving second install set data indicating the install set component;
determining whether the install set component is stored in the component cache;
in response to determining that the install set component is not stored in the component cache, requesting the install set component; and
in response to determining that the install set component is stored in the component cache, refraining from requesting the install set component.

14. The computer-implemented method of claim 13, comprising:
in response to determining that the install set component is stored in the component cache, retrieving the install set component from the component cache.

15. The computer-implemented method of claim 11, comprising:
determining whether the install set component is stored in the component cache at least in part by:
querying a component status database, the component status database storing a status for retrieved components; and
storing a status for components being retrieved; and
in response to the component status database storing the status for retrieved components, determining that the component cache comprises the install set component.

16. A non-transitory, computer-readable medium, comprising computer-readable instructions that, when executed by one or more processors of one or more computers, cause the one or more computers to:
receive install set data, the install set data indicating an install set component to install;
request the install set component via a component repository;
receive, from the component repository, the install set component; and
provide the received install set component to a component cache, causing the component cache to cache the received install set component for subsequent use.

17. The non-transitory, computer-readable medium of claim 16, comprising computer-readable instructions that, when executed by the one or more processors of the one or more computers, cause the one or more computers to:
cause generation of a component package comprising the received install set component; and
transmit a notification to a local server manager that the component package is ready for installation.

18. The non-transitory, computer-readable medium of claim 16, comprising computer-readable instructions that, when executed by the one or more processors of the one or more computers, cause the one or more computers to:
transmit, to an entitlement service, a token; and
in response to transmitting the token, prepare to receive the install set data in anticipation of the entitlement service validating the token.

19. The non-transitory, computer-readable medium of claim 16, comprising computer-readable instructions that, when executed by the one or more processors of the one or more computers, cause the one or more computers to:
determine whether the install set component is stored in the component cache at least in part by querying a component status database, the component status database storing a status for an error in retrieving components; and
in response to the status for the error, repeat retrieval of the install set component.

20. The non-transitory, computer-readable medium of claim 16, comprising computer-readable instructions that, when executed by the one or more processors of the one or more computers, cause the one or more computers to:
determine whether the install set component is stored in the component cache at least in part by querying a component status database, the component status database storing a status for retrieving components; and
in response to the status for retrieving components, wait until the install set component is stored in the component cache.
